(19) United States
(12) Patent Application Publication
(10) Pub. No.: US 2025/0287019 A1
(43) Pub. Date: Sep. 11, 2025

(54) Region Of Interest Encryption And Processing for Media Items

(71) Applicant: APPLE INC., Cupertino, CA (US)

(72) Inventors: Dimitri PODBORSKI, Cupertino, CA (US); Alexandros TOURAPIS, Los Gatos, CA (US)

(21) Appl. No.: 19/034,260

(22) Filed: Jan. 22, 2025

Related U.S. Application Data
(60) Provisional application No. 63/563,755, filed on Mar. 11, 2024.

(51) Int. Cl. H04N 19/167; G06F 21/62; G06V 10/25; H04N 19/117; H04N 19/70

(52) U.S. Cl. CPC H04N 19/167; G06F 21/6254; G06V 10/25; H04N 19/117; H04N 19/70

(57) ABSTRACT

Techniques are disclosed for representing media items in a way that protects content representing information deemed sensitive by media item authors and allows media consumers both those with access rights to the sensitive content and those that do not have such access rights, to access content of the media item. They also provide for generating alternative representations that may be desired for different applications. According to these techniques, one or more regions of interest (ROI) are detected from content of the media item, and one or more obfuscated copies or alternative versions of the ROI(s) are generated. Source content of the ROI(s) can be encrypted and placed in a file representing the media item. The obfuscated copies/variants of the ROI(s) are created and then obscured. These copies/variants of the ROI(s) can be placed in the file representing the media item. And, of course, content of the media item corresponding to regions outside the ROI(s) may be represented in the file. These techniques allow media consumption devices of all kinds to access the media file. For those media consumption devices that have certain access rights to process and/or decrypt specific ROI variants, the media consumption device may decode the respective obscured ROI data and compile a recovered media item by combining the respective obscured ROI data with data of the non-ROI regions. For media consumption devices that do not possess access rights to process and/or decrypt the encrypted ROI, the media consumption device may only process the non-ROI regions and potentially default representation of the obscured ROI data. Other applications provide for controller presentation of alternative representations of ROI content under application control, such as, for example, advertisement insertions or marketing overlays.

### CROSS REFERENCE OF RELATED APPLICATIONS

This application claims the benefit of U.S. Provisional Application No. 63/563,755, filed on Mar. 11, 2024, the disclosure of which is incorporated by reference herein.

### BACKGROUND

Data protection and privacy is an important value in the development of information technology products and services. Every day, users of consumer electronics products, whether smartphones, tablet computers, or other media devices, share an enormous amount of multimedia content such as photos and videos over the Internet. While it often is possible to restrict access to such multimedia content, prior techniques typically either prohibit access or grant access to a certain group of users, for example, when using shared albums in the Photos application, or sharing videos with a group of people in a messenger application, and the like. Typically, access grants or denials operate on a media asset as a single, granular unit.

### BRIEF DESCRIPTION OF THE DRAWINGS

FIG. 1 is a system diagram illustrating a communication system suitable for use with the proposed embodiments.

FIG. 2 illustrates a method according to an embodiment of the present disclosure.

FIG. 3 illustrates application of the method of FIG. 2 to an exemplary image.

FIG. 4 illustrates application of the method of FIG. 2 to another exemplary image.

FIG. 5 illustrates application of application of the method of FIG. 2 to a further exemplary image.

FIG. 6 illustrates an exemplary file according to an embodiment of the present disclosure.

FIG. 7 illustrates an exemplary file according to another embodiment of the present disclosure.

FIG. 8 illustrates an exemplary application of hierarchical keys according to an embodiment of the present disclosure.

FIG. 9 illustrates a system according to another embodiment of the present disclosure.

### DETAILED DESCRIPTION

Embodiments of the present disclosure provide techniques for representing media items in a way that protects content representing information deemed sensitive by media item authors and allows media consumers, both those with access rights to the sensitive content and those that do not have such access rights, to access content of the media item. According to these techniques, a region of interest (ROI) is detected from content of the media item. Source content of the ROI may be processed and/or encrypted, and placed in a file representing the media item. One or more copies of the ROI is created and then obscured. This second copy of the ROI also is placed in the file representing the media item. And, of course, content of the media item corresponding to regions outside the ROI may be represented in the file.

These techniques allow media sink devices of all kinds to access the media file. For those media sink devices that lack access rights to decrypt the encrypted ROI, the media sink device may decode the obscured ROI data and compile a recovered media item by combining the obscured ROI data with data of the non-ROI regions. For media sink devices that possess access rights to decrypt the encrypted ROI, the media sink device may decrypt to encrypted ROI data and compile a recovered media item by combining the decrypted ROI data with data of the non-ROI regions.

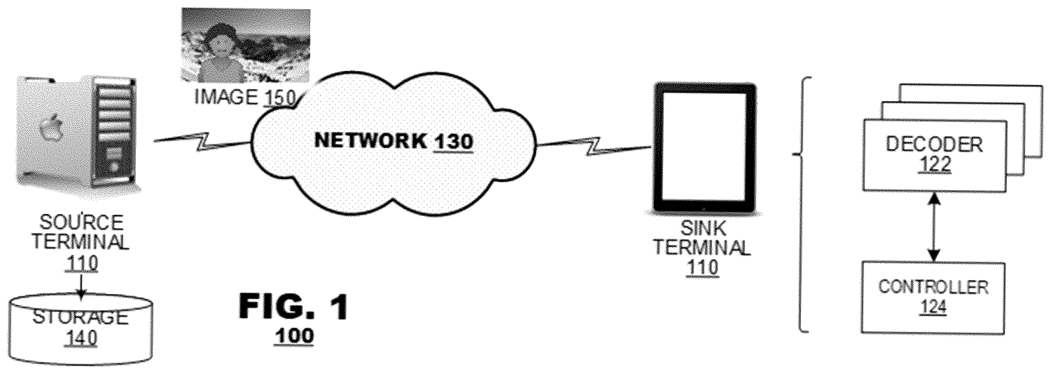

FIG. 1 is a system diagram illustrating a communication system 100 suitable for use with embodiments of the present disclosure. FIG. 1 illustrates a source terminal 110 and a sink terminal 120 provided in mutual communication by a network 130. The source terminal 110 may make media content available for download and consumption by the sink terminal 120. For this purpose, the source terminal 110 either may generate media content on an on-the-fly basis or, alternatively, it may store the media information on a local storage device 140. For example, FIG.

1 illustrates an image 150 that is stored by the source terminal 110 and made available to the sink terminal 120 over the network 130.

Source and sink terminals 110, 120 may operate according to interface specifications that define how image information is represented. As relevant to the present discussion, the interface specifications may define file formats for image information that is to be exchanged between the terminals. Often, the image information itself may be placed within “payload” field(s) of the file format. The file format may contain other field(s) for “overhead” information, which represent(s) characteristics of the payload information. The image information typically would have been coded by a source coder, which applies a selected compression algorithm to the image content before it is made available by a source terminal 110. The source coder may operate according to its own interface specification. Thus, a single image may be represented by multiple interface specifications. It may also occur that image information is provided redundantly within an image file; for example, a common portion of image data might be coded according to a first compression algorithm and placed in a first payload field, then coded according to a second compression algorithm and placed in a second payload field.

A sink terminal 120 typically has one or more decoders available to decode images. In application, a controller at the sink terminal 120 will interpret overhead information provided with a coded image 150 according to the interface specification to which the file's format adheres. When the controller 124 recognizes a compression algorithm that has been applied to a given set of payload information, it may engage an appropriate decoder at the sink device to invert coding processes applied by the source terminal's coder. When a file contains redundant image data and the sink terminal 120 possesses decoders sufficient to decode multiple ones of the redundant copies, the sink terminal 120 typically selects a single one of the redundant representations to decode according to a predetermined selection hierarchy. For example, the file may arrange the redundant copies in a predetermined order and the sink device 120 may select a first copy in order for which it possesses an appropriate decoder.

In FIG. 1, the source terminal 110 is illustrated as a server and the sink terminal 120 is illustrated as a tablet computer, but the principles of the present disclosure are not limited to any device. Embodiments of the present invention find application with laptop computers, tablet computers, media players and/or dedicated video conferencing equipment. The network 130 represents any number of networks that convey information between the terminals 110, 120, including, for example, wireline and/or wireless communication networks. The communication network 130 may exchange data in circuit-switched and/or packet-switched channels. Representative networks include telecommunications networks, local area networks, wide area networks, and/or the Internet. For the purposes of the present discussion, the architecture and topology of the network 130 is immaterial to the operation of the proposed embodiments unless explained hereinbelow.

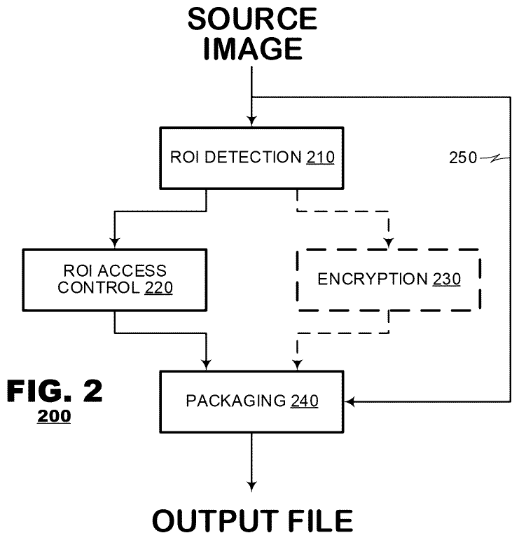

FIG. 2 illustrates a method 200 according to an embodiment of the present disclosure. The method 200 may be performed on a source terminal 110 (FIG. 1) to apply access protections to image content from a source image designated as a region of interest (“ROI”). The method 200 may begin by performing ROI detection on the source image (box 210). ROI detection may identify spatial locations of the source image that contain content designated for access protections. For example, regions of image information that are determined to contain faces or identifiers of location information may be designated for access protection. The method 200 may perform parallel operations on ROIs when multiple ROIs are detected within a single image. In one operation, image content of the ROI may be processed by an ROI obfuscation technique (box 220), which degrades ROI content. In another operation, image content of the ROI may be processed by an access control technique (box 230), which restricts access to such content. The obfuscated content of the ROI and the access controlled content of the ROI both may be processed by a packaging technique, which could include compression of the assets (box 240), which places these copies of ROI content in an image file according to a governing interface specification.

ROIs may be determined in a variety of ways. An ROI, for example, may be defined as a spatial region of a still image that is determined to possess content to which it is desired to attach access controls. An ROI, in a three dimensional image, may be defined as a volumetric region of an image to which access controls should attach. An ROI, in a video application, may be defined both spatially and temporally; for example, an object in motion picture video may be classified as an ROI and its movement across a span of video may be processed as the ROI.

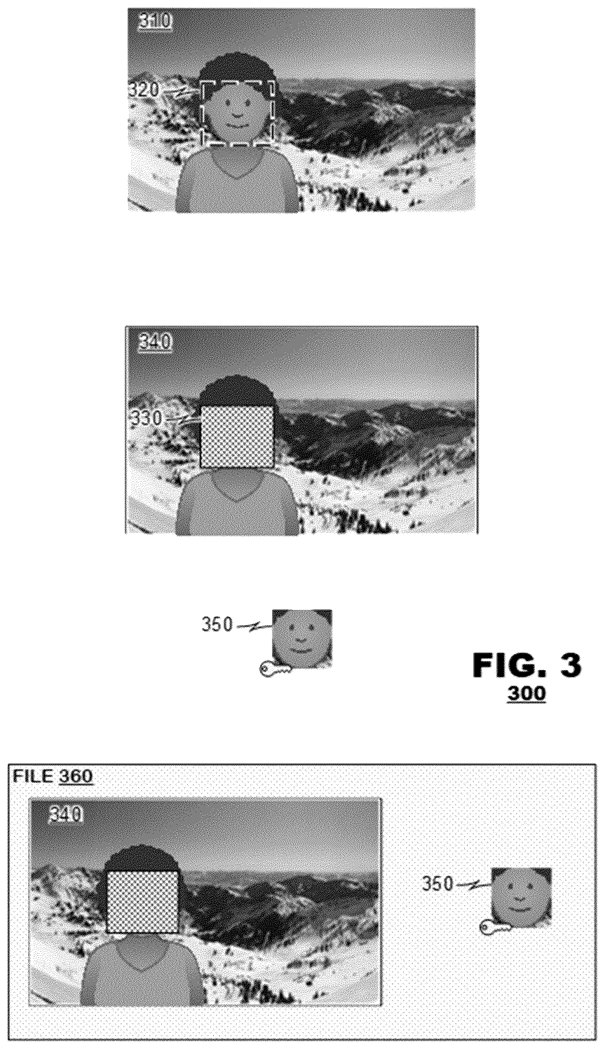

FIG. 3 illustrates application of the method 200 (FIG. 2) to an exemplary image 310. In this example, ROI detection (box 210) is configured to recognize faces within image data. Application of this process causes a source terminal 110 to generate an ROI 320 from a source image 310. Application of ROI obfuscation (box 220) may cause the sink terminal 110 to generate an obscured ROI 330 from the identified ROI 320. In this example, content of the ROI 320 from the source image 310 is replaced with content of the obscured ROI 330, yielding a new image 340. Application of the access control process (box 230) may cause the sink terminal 110 to generate an encrypted ROI 350 from the identified ROI 320. The modified image 340 and the encrypted ROI 350 may be placed within an image file 360 that is made available to sink devices.

The example of FIG. 3 is a simple one in which a single ROI 320 is detected from a source image 310. The principles of the present disclosure may be applied to images having greater complexity from which multiple ROIs are detected. In such cases, the method 200 may be applied iteratively to each ROI detected from a source image.

The principles of the present disclosure find application with ROIs of different types. As shown in the example of FIG. 3, ROIs may be detected from facial recognition processes to detect human faces. In such applications, it is not necessary to mark all detected faces as an ROI; operators of source devices 110 may determine that a source device 110 should determine the identity of detected faces (e.g., ROIs should be applied to faces representing specific people rather than all people) and may cause the techniques proposed herein to be applied to ROIs representing those specific people. ROI detection also may be applied to identify image content that indicates geographic location of source content. In a further embodiment, ROI detection may be based on temporal identifiers in media content. For example, metadata or image content that indicates a time of media capture may be assigned as an ROI. ROI access controls may alter image content that reveals temporal information (such as the color of a sky, the presence of a sun or moon in image content, or indicators of seasons) to provide access control. Thus, an ROI detector may recognize visual elements such as road signs, landmarks, and other indicia of location, which may be designated for further processing by the method 200 of FIG. 2. ROI detection may be based on object detection to detect objects of a specific type.

The obfuscation processing may generate an alternate version of the ROI that is degraded with respect to the source version of the ROI in a predetermined manner. ROI obfuscation (box 220) may occur in a variety of ways. In one example, image content of an ROI 320 simply may be replaced with content from another source that has no relationship to image content of the ROI 320. In another example, image content of the ROI 320 may be filtered sufficiently strongly to remove structural features present in the ROI's content that causes the ROI detection process (box 210) to recognize the ROI. For example, filtering of content representing a human face might yield a heavily blurred ROI image 330 that has image content representing overall skin tone of the subject represented by the ROI but in which facial features are no longer perceptible. In a further example, image content of the ROI 320 may be spatially rearranged on a random basis, which may cause information content of the ROI 320 to be unrecoverable by a source terminal. And, of course, these techniques may be combined. For example, dummy image content may be intermixed with image content of the ROI 320 before spatially randomizing the resultant content.

In an embodiment, each ROI 350 may have metadata (not shown) assigned to it that identifies a source of the ROI. For example, it may be provided in Coalition for Content Provenance and Authenticity (C2PA) signaling. On decode, a sink device may select, from among many candidate ROIs, an ROI for decode based on source identifiers provided in the C2PA signaling.

ROI encryption (box 230) typically will involve encrypting the ROI content 320 according to an encryption key. The encrypted ROI will be recoverable only by sink devices (FIG. 1) that have a key that is appropriate to decrypt the encrypted ROI 350.

The principles of the present disclosure may be extended to generate more than two instances of ROIs 330, 350 from a single source ROI 320. Such applications permit an operator of a source device to personalize ROIs, where different ROI instances may be presented based on different operating contexts of sink device(s). For example, different ROIs may be accessed based on metadata and information associated with a sink device 120 such as a user ID associated with a user of the sink device, a group ID to which that user belongs, metadata identifying the sink device's location (e.g., GPS position data), a current time at the sink device, and/or an area of the image currently being displayed on a screen of the sink device. As an example, a particular user belonging to a certain group A could see the encrypted ROI 350 while users belonging to the group B would see a first overlay image X (not shown), and everyone else would see a second overlay image Y (also not shown).

Access to ROIs may be conditioned on other viewing circumstances at a sink device 120. For example, it is common in many consumer electronic devices to use a local camera at a sink device 120 and facial recognition to grant access to functions of a sink device. One such example is FaceID controls provided in certain Apple devices. Access to ROIs may be governed by facial recognition applied to image information captured locally at a sink device. In one example, a user of the sink device 120 may be identified by facial recognition, which may be used to access an ROI (say, an encrypted ROI) to which the user has access rights. In another example, a sink device may use facial recognition to determine and/or recognize a number of people currently using the sink device; the sink device may grant access to an ROI according to access rights of a recognized face having a lowest access rights. And, in another embodiment, if a sink device detects a face in its camera's field of view but cannot recognize the face (e.g., the identity of that person is unknown), then the sink device may access ROI content at the lowest level access rights within the image 360.

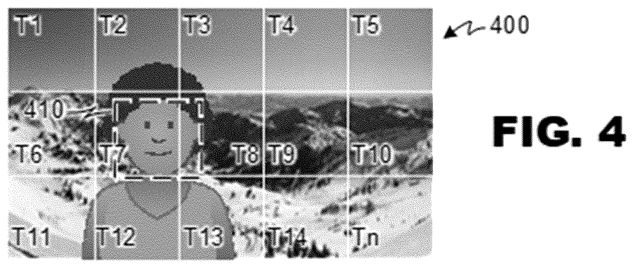

The principles of the present disclosure apply to a variety of different image packaging formats. In one application, shown in FIG. 4, an image 400 may be partitioned into rectangular areas T1-Tn, often called “tiles.” An image packing process may represent the image as a collection of these tiles T1-Tn, which are arranged spatially according to a predetermined pattern such as a raster scan pattern. In such applications, tiles T7, T8, T12, and T13 that contain ROIs 410 may be subject to the obscuring and encryption processing discussed above in FIG. 2. It is not required that an ROI 410 be aligned to partitions between the tiles. An image file generated from such tiles may contain obscured tiles generated according to the ROI obfuscation techniques (box 220) proposed herein and encrypted tiles generated according to the ROI encryption techniques (box 230). In such embodiments ROI obfuscation (box 220) need only obscure a portion of each tile T7, T8, T12, and T13 in which the ROI 410 is detected; other portions of the tiles T7, T8, T12, and T13 need not be altered.

In another embodiment, ROI obfuscation techniques may be applied to the T7, T8, T12, and T13 in which the ROI 410 is detected as discussed and a single encrypted region is generated that corresponds to the detected ROI 420. In such an embodiment, the image file may contain metadata that identifies a spatial location of the ROI 420 that is recovered by decryption, which a sink device 120 may use to develop a recovered image from recovered tiles T1-Tn and the decrypted ROI 420.

The principles of the present invention also apply to non-rectangular partitioning schemes, including those that partition images into triangles, pseudo-triangles, Voronoi cells, and the like.

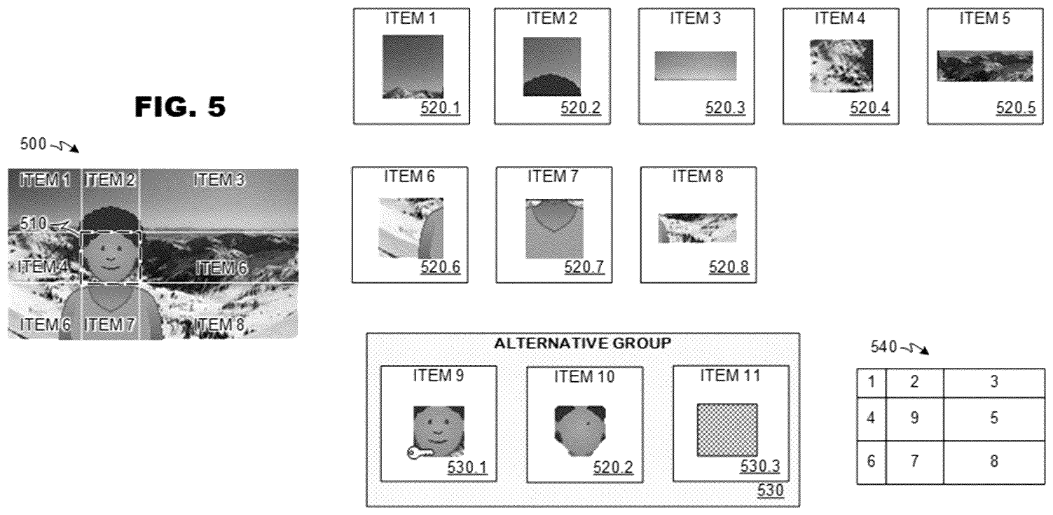

The principles of the present disclosure also find application with image packaging specifications that partition images in a more flexible manner, for example, as shown in FIG. 5. The High Efficiency Image File Format (commonly, “HEIF”) specification (ISO/IEC 23008-12) is an example of an image packaging specification that allows a source device 110 to partition images non-uniformly. As shown in FIG. 5, an image 500 may be partitioned in a manner that aligns image partitions to boundaries of an ROI 510. Thus, the ROI boundaries may define partitioning lines that traverse an image 500 in the boundaries' respective directions (e.g., either horizontally or vertically as the case may be). In the HEIF packaging format, each portion of the image 500 so partitioned may be represented in a HEIF item data structure. Thus, in the example of FIG. 5, the four partitioning lines that traverse the image 500 may partition the image into nine partitions, each of which is provided its own item 520.1-520.8 and 530 in the HEIF image file. Each item 520.1-520.8 and 530 may contain metadata regarding the image content and payload information representing the partition's image content.

The HEIF specification allows items to be defined in alternative groups, which provide different representations of a common image partition. According to an embodiment, alternative versions of ROIs processed according to the foregoing embodiments (FIG. 2) may be provided within an image file in an alternative group 530. The example of FIG. 5 illustrates three copies 530.1, 530.2, 530.3 of the ROI provided in the alternative group 530. The first copy 530.1 may be the encrypted ROI, which may be accessed by a sink device (not shown) that has a decryption key for the encrypted ROI. The second copy 530.2 in this example is a heavily filtered version of the ROI, which has been filtered sufficient to remove features of the ROI. The third copy 530.3 is a version of the ROI that has dummy content.

In this example, the HEIF image may contain metadata 540 that identifies spatial relationships of the items 520.1-520.8 and 530 within the image.

In HEIF, items within an alternative group are placed within an order that defines a priority among the alternative group items for decoding. The order typically is determined by a source device that generates the HEIF file. In the example of FIG. 5, the order of alternative group items 530.1-530.3 may place the encrypted ROI 530.1 first in order for decode, the filtered ROI 530.2 second in order for decode, and the dummy content ROI 530.3 third in order for decode.

As a sink device (not shown) interprets the items within the alternative group 530, it may determine, in the priority order, whether it can process the respective item 530.1-530.3. Typically, the sink device decodes the first item within the alternative group that it determines it can decode. Thus, in the example of FIG. 5, a sink device that possesses a decryption key (and access rights) to decode the encrypted ROI 530.1 may decode it. This would allow the sink device to recover a highest quality copy of the ROI from the image file. The sink device would not evaluate the other items 530.2, 530.3 in the alternative group 530.

A sink device that lacks the decryption key or access rights to the encrypted ROI 530.1 may progress to the next item 530.2 in the alternative group 530. In this circumstance, the sink device would determine whether it can decode the filtered ROI 530.2, for example, by determining whether it has sufficient access rights to it. If the sink device has sufficient access rights to decode the filtered ROI 530.2, the sink device may decode it. Otherwise, the sink device may access the ROI containing dummy content 530.3. Although not required, it is expected that, in implementation, an alternative group 530 will have one variant of the ROI 510 that all sink devices are permitted to access. In the example of FIG. 5, the ROI having dummy content 530.3 is defined so that it is accessible by all sink devices.

In another embodiment, alternative versions of ROIs processed according to the foregoing embodiments (FIG. 2) may be provided within an image file as alternative derived items. The HEIF specification also allows different representations of a common image partition to be represented using the derived item syntax of the specification.

Although the foregoing examples consider image data represented by two-dimensional content, the principles of the present disclosure are not so limited. The principles of the present disclosure find application with volumetric images composed of, for example, point cloud or mesh data representations. In such applications, one or more Volumes of Interest (VOI(s)) may be defined, which may be protected against unauthorized use by encryption. In such applications different subset(s) of volumetric data may presented inside the VOI depending on the user or a user group and their associated access rights.

In HEIF, items are identifiable by a four-character code (4CC) indicating the type of the box. Thus, the box proposed in the present disclosure may be made distinguishable from other types of HEIF boxes by a unique character code and box type. For discussion purposes within this document, assume that the item 530.1 containing the encrypted ROI may be designated with a code (say, “proi”) to indicate that the ROI item is protected and which could contain additional signaling that would allow modification of the data in the ROI.

In an application, different keys may be used to identify item(s) to which access is provided within an ROI. From one perspective, the keys may themselves be an identifier to identify personalization content that is associated with that key.

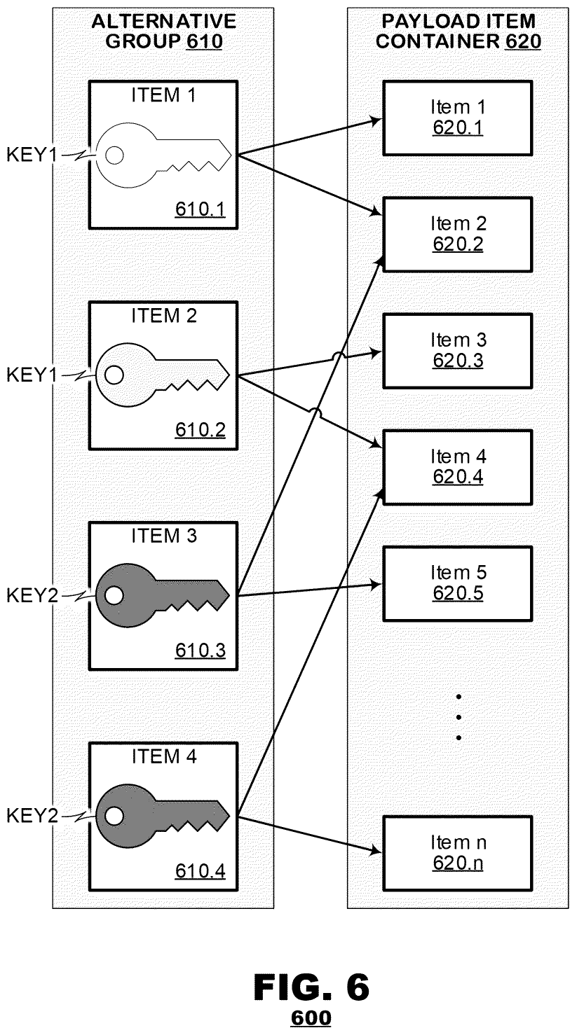

FIG. 6 illustrates an exemplary file 600 according to an embodiment of the present disclosure. In this example, the file has a first alternative group 610 of identification items 610.1-610.4 and a plurality of payload items 620.1-620.n in a second alternative group 620. The items 610.1-610.4 in the first alternative group may identify requirements for accessing item(s) in the second alternative group 620. In this example, a key may function as an access identifier for personalization content. The item(s) 610.1, 610.2, 610.3, 610.4 in the first alternative group 610, in this embodiment, may contain a key identifier (KEY1, KEY2) that applies to the respective item 610.1, 610.2, 610.3, 610.4 and an identifier of payload item(s) 620.1, 620.2, . . . 620.n to which the respective item 610.1, 610.2, 610.3, 610.4 relates. During operation, a sink terminal (FIG. 1) may compare its locally stored keys to identifiers of the keys provided in the first alternative group items 610.1-610.4 determine which item(s) 620.1, 620.2, . . . , 620.n of the second alternative group 620 to which it has access rights. When a given sink device has access rights to multiple items of the second alternative group 620, it may select one of the items according to a predetermined prioritization scheme (such as first in order within the alternative group 620).

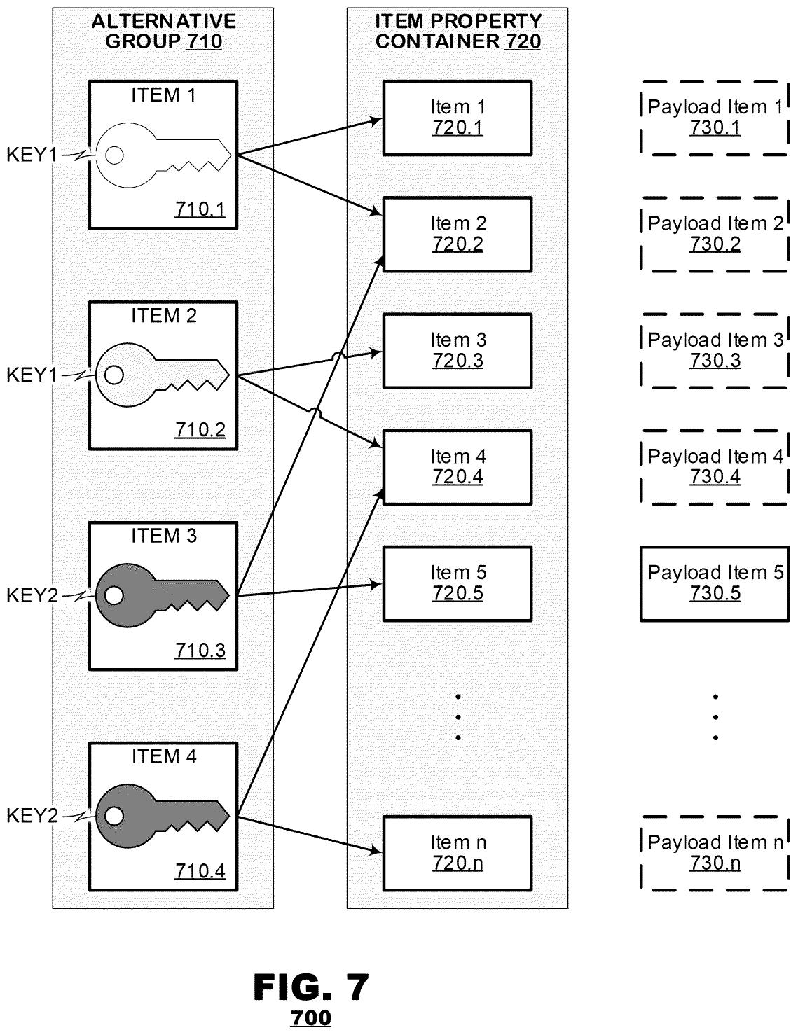

In an embodiment, multiple items of metadata may be utilized to determine the payload item(s) to which a sink device has access rights. One such embodiment is illustrated in FIG. 7, in which a file 700 contains multiple alternative groups 710, 720, and 730. A first alternative group 710 may contain identification items 710.1-710.4 containing a key identifier (KEY1, KEY2) that applies to the respective item 710.1, 710.2, 710.3, 710.4 and an identifier of item(s) 720.1, 720.2, . . . 720.n of the second alternative group 720 to which the respective item 710.1, 710.2, 710.3, 710.4 relates. Items 720.1, 720.2, . . . 720.n of the second alternative group 720 may identify other properties that define further access rights to respective items 730.1, 730.2, . . . 730.n of payload items in the third alternative group 730.

The items 710.1, 710.2, 710.3, 710.4 also may contain data identifying the item(s) 720.1, 720.2, . . . , 720.n in the second alternative group 720 to which each item 710.1, 710.2, 710.3, 710.4 relates,. Along with other access requirement information (not shown) for accessing items 720.1, 720.2, . . . , 720.n in the second alternative group 720. When a given sink device has access rights to multiple items of the second alternative group 720, it may select one of the items according to a predetermined prioritization scheme. For example, in the example of FIG. 7, the items of the second alternative group 720 define properties of payload items 730.1-630.n in a file 700. A sink device may select an item 720.1, 720.2, . . . , 720.n for processing based on a comparison of item properties to properties of the local rendering environment in which the sink device operates (for example, screen size or resolution, decoder type, ambient environment, and the like). Alternatively, the sink device may select an item (e.g., 720.2) according to a predetermined prioritization scheme, such as first in order, among multiple items to which it has access rights.

During operation, a sink device (not shown) may compare its locally stored key(s) to key identifiers contained in items 710.1, 710.2, 710.3, 710.4 of the first alternative group 710 and determine which items 720.1, 720.2, . . . , 720.n of the second alternative group 720 to which the device has access rights. The sink device thereafter may compare local properties of the device to property identifiers contained in the items 720.1, 720.2, . . . , 720.n of the second alternative group 720 to which the device has access rights to determine whether its properties match those defined in the respective items 720.1, 720.2, . . . , 720.n of the second alternative group 720. The sink device may access a payload item (say, item 730.2) for which its key and its local properties match the requirements specified in the items 710.1, 720.2 of the first and second alternative groups 710, 720.

By way of example, the metadata stored in items 720.1-720.n of the second alternative group 720 may be codec type or codec layer metadata; metadata for interactive rendering such as zoom factor thresholds, pan/tilt/orientation thresholds, ambient light thresholds; geolocation information; or information extracted from the live feed of the front/rear camera unit, (e.g., face recognition/face ID, detecting where the user is looking within the image). In other embodiments, lidar sensor data or availability of other auxiliary image data (alpha/disparity/depth) for the corresponding regions could be used as second alternative group 720 metadata.

Auxiliary data such as alpha mask, disparity or depth information can also be selectively protected according to the above scheme. Such a process can enable “premium” quality image effects only to a certain group of users as, for example, only users with a key can have access to the depth data of a face region in the image and can apply filters which are using depth information.

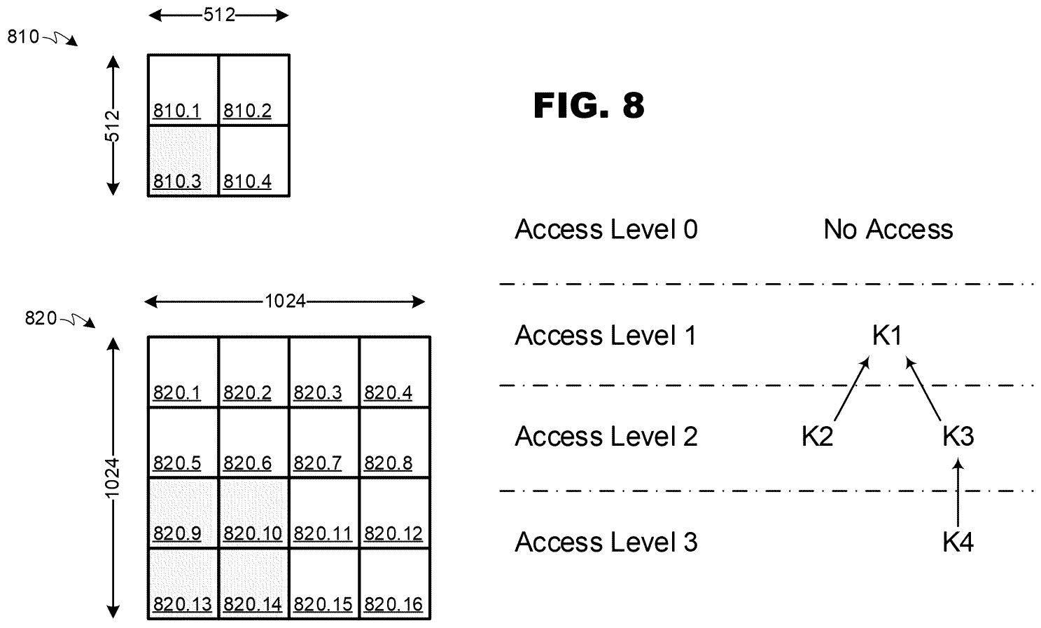

In another embodiment, multiple keys can be organized to depend on each other hierarchically, which allows image authors to define access levels to different images (or image regions) according to these key. FIG. 8 visualizes an embodiment involving hierarchical keys according to an embodiment of the present disclosure. In this example, a “root” key (K1) is assigned to access level 1 and two “leaf” keys K2 and K3 are both assigned to the access level 2. Further in this example, another leaf key K4 depends on key K3 and is assigned to access level 3. In this embodiment, in order to be able to decrypt the image data at a certain access level, a sink device (not shown) must have the key that applies to the access level and any parent keys of that key. The encrypted content itself can be produced by re-encrypting the encrypted content of the previous level.

The example of FIG. 8 also illustrates primary grid items 810, 820 for an image 800 that can be recovered at different resolutions. In this example, decode of the grid items 810.1-810.4 may recover an image at 512×512 pixel resolution, while decode of the grid items 820.1-810.16 may recover an image at 1024×1024 pixel resolution. In this example, a single bottom-left tile 810.3 of the lower resolution image is encrypted with the access level 1 key K1. The same image region of a higher resolution image, corresponding to tiles 820.9, 820.10, 820.13, and 820.14, may be encrypted in two different access levels 2, 3 with three different keys, K2, K3 and K4. This can make it possible to divide a huge image into smaller regions and selectively give a certain group of people access to different qualities of certain regions. Users who lack access to a certain access level would not get access to high-quality or higher resolution versions of the regions and would drop back to a previous access level, which may need to be upscaled to a larger image size, as if appropriate, prior to rendering. Users without any access level assignment could get an obfuscated version of the region. In such a hierarchical key structure it is also possible that one key depends on multiple keys from different access levels. In another example the output of the decryption operation using one key (e.g., pixel data), can be used as an input of the decryption process of the following access layer (e.g., cipher block chaining).

The selective encryption concepts described above with respect to regions of image/video data and the data associated with those regions (selective metadata encryption) may be extended to interactive features that are associated with those regions. Such interactive features can include, for example, playback of certain audio tracks when zooming into a region, dynamic overlays depending on zoom/pan interactions, swapping items (x-ray view etc.), and transitions between views/images/videos when performing interactive actions pan/tilt/zoom etc.

In another embodiment, ROI encryption may be accomplished using overlays (e.g., ‘iovl’ derived image in HEIF). Encryption may be applied to encrypt a portion of an encoded bitstream that represents a ROI with sensitive content using the HEVC tiles.

Image/video encoding processes may be constrained according to identified ROI(s). When an ROI is identified, a set of tiles that encompasses the ROI would not be used by an encoder to code image/video outside the ROI using the ROI's tiles as a reference. For example, intra coding dependencies on the encrypted regions shall be disallowed, which ensures that a sink device that decodes an image without a key, would not encounter new the decoding artifacts that would arise if the sink device's decoder required prediction content from a protected region to which it does not have access.

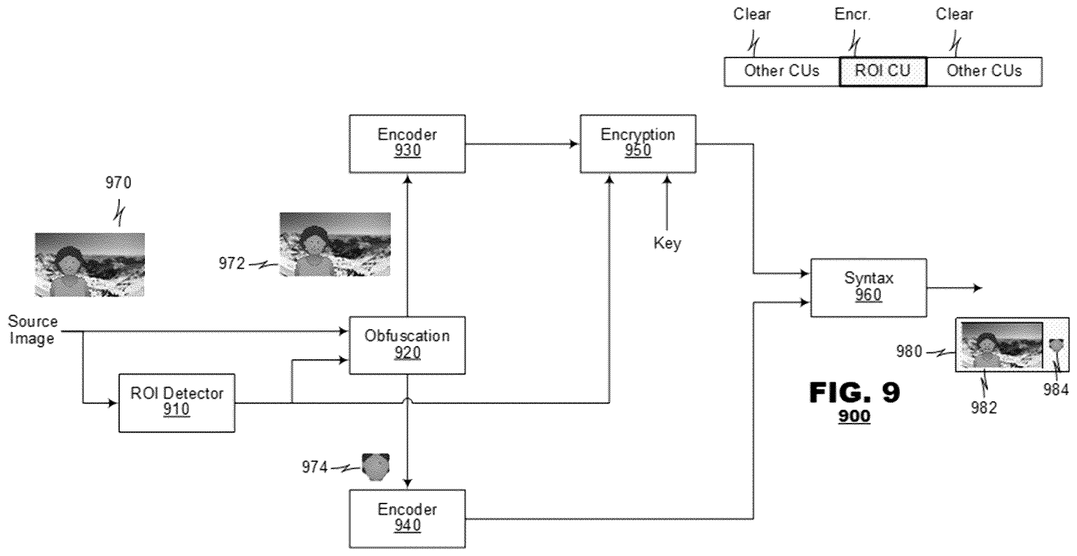

FIG. 9 illustrates a system 900 according to another embodiment of the present disclosure. The system 900 may include an ROI detector 910, an obfuscation unit 920, a pair of encoders 930, 940, an encryption unit 950, and a syntax unit 960. The system 900 may receive a source image 970 and perform ROI detection 910 on the source image to identify regions of interest from content within the source image 970. The obfuscation unit 920 may apply obfuscation techniques to areas of the source image 970, generating multiple resultant images therefrom. A first image 972 is a replica of the source image. A second image 974 may be an obscured image corresponding to an ROI identified from within the source image 970.

One encoder 930 may receive the replica image 972 and may code it according to a source encoding technique. Source encoding may be performed according to a predetermined inter-operability standard for coding image or video data, for example, according to one of the MPEG family of standards. Such coding operations may parse the image 972 into a plurality of coding units (“Cus”), then apply predictive and transform coding techniques to each CU to yield a compressed representation of the coding unit. Coded CUs may be output to the encryption unit 950, which applies encryption to the CU(s) that are associated with detected ROIs but leaves other coded Cus unencrypted. The encrypted and unencrypted Cus may be output to a syntax unit that may compile the coded image into a file 976 according to a coding syntax (such as the syntax of the High Efficiency Video Coding (HEVC) of the AOMedia Video 1 (AV1) standards).

Video data of obscured ROI(s) 974 may be input to another encoder 940. Here, again, the encoder 940 may perform source encoding on the obscured ROI according to a predetermined source coding protocol. Coded data of the obscured ROI 974 may be output to the syntax unit 960, which may compile the coded data of the obscured ROI 974 into the file 974.

In this embodiment, the protected image 982 can be stored as a single item in the file 980, and an obfuscated/unprotected overlay image 984 can be stored next to it in the same file 980. When a sink device is unable to decrypt the encrypted portion of the protected image 982, it may process clear portion(s) of the protected image 982, and it may render the obfuscated ROI image 984 on top of a region that the sink device is unable to access. Additional metadata can be defined to enable/disable transformative properties (e.g., overlay) depending on certain conditions (e.g., key not present).

The principles of the present disclosure can be extended to volumetric images where, for example, a point cloud or a mesh data is selectively encrypted to protect VOIs. In such applications, different subset of volumetric data may be presented within volumetric images, which may be detected as VOIs depending on the user or a user group. In such applications, attribute data (e.g., texture data, normal and/or material id information) may be protected as described hereinabove by, for example, encrypting the texture data and generating obfuscated VOI data for used by sink devices that lack access rights to the encrypted data. In designated use cases, data representing object geometry also may be protected according to the techniques proposed herein.

The tiling information can be determined by detection or can be supplied by external means, for example in Visual Volumetric Video-Based Coding (V3C (e.g., V-PCC)) a Volumetric Tiling information SEI can be used to identify the regions/volumes of interest. V3C selective encryption can be applied on the atlas data, leaving the video-based component data untouched. This can already be a sufficient protection method for a certain number of applications.

To increase the privacy even more, the corresponding information from the component video tracks can also be selectively encrypted. For example, videos can be split into different regions as already described above and the same concepts are applied.

Multiple security access levels can be defined while encrypting different components of V3C data in a manner that is analogous to techniques discussed in FIG. 8. For example, encryption of the atlas data regions is the access level 1 with a key K1. Encryption of the geometry component tiles is the access level 2 with a key K2 and the encryption of the regions from the attribute component is assigned to a level 3, etc.

Normals, transparency, and other auxiliary information can also be selectively encrypted to allow premium processing capabilities and interactive features when rendering the content on the device.

The rendered output (when no decryption key is present) may consist of voxels, which do not distort the volumetric object. Similar to the 2D examples described above, a concept of derived visual items can be used to “replace” the broken data with previously prepared point cloud or mesh data.

Similar to 2D image/video data where the data can be partitioned using different shapes (e.g., 2D grid with rectangular regions, triangles, Voronoi cells etc.), the volumetric content can also be partitioned into sub-regions. A simple partitioning method would be using cuboid regions in a volumetric grid, but other methods could also be used (e.g., tetrahedrons, 3D Voronoi cells, etc.). Different sub-regions could be selectively encrypted similar to traditional 2D approach. Standards, such as HEIF could be extended to support volumetric sub-regions and selective encryption of those regions.

In many volumetric imaging applications, users may have six degrees of freedom (DoF) to freely move throughout a rendered scene and potentially can go “inside” the objects. In an overlay application, if a scene were rendered with one object on top of another, a user might still be able to access content under the “overlay” through such navigation. In some cases, the application may restrict the user movements to a certain threshold, while in other applications (e.g., Augmented Reality applications) it is not possible. However, in 3 DoF+ applications, as for example in the MPEG Immersive Video (MIV), Visual Volumetric Video-based Coding (V3C), or similar standards, the same 2D overlay concepts may apply, especially in the multi-plane image approach where multiple images are assigned to different planes at different depth levels, to emulate parallax effects. By protecting VOIs at the file generation stage, the principles of the present disclosure prevent access to protected content even in such navigation scenarios because a sink device that lacks access to protected information will be unable to recover the protected content even before rendering is performed.

Additional metadata, which can be selectively encrypted to enable additional interactive features, could be for example information on how voxels of a point cloud or mesh vertices relate to each other. This metadata could for example be the information on the shape and size of voxels or assignment of material IDs to mesh faces and could be used for an interpolation process/or mesh conversion process.

The foregoing discussion has described the various embodiments of the present disclosure in the context of coding systems, decoding systems and functional units that may embody them. In practice, these systems may be applied in a variety of devices, such as mobile devices provided with integrated video cameras (e.g., camera-enabled phones, entertainment systems and computers) and/or wired communication systems such as videoconferencing equipment and camera-enabled desktop computers. In some applications, the functional blocks described hereinabove may be provided as elements of an integrated software system, in which the blocks may be provided as elements of a computer program, which are stored as program instructions in memory and executed by a general processing system. In other applications, the functional blocks may be provided as discrete circuit components of a processing system, such as functional units within a digital signal processor or application-specific integrated circuit. Still other applications of the present invention may be embodied as a hybrid system of dedicated hardware and software components. Moreover, the functional blocks described herein need not be provided as separate elements. For example, although FIGS. 1-9 illustrate components of video coders and decoders as separate units, in one or more embodiments, some or all of them may be integrated and they need not be separate units. Such implementation details are immaterial to the operation of the present invention unless otherwise noted above.

Further, the figures illustrated herein have provided only so much detail as necessary to present the subject matter of the present invention. In practice, video coders and decoders typically will include functional units in addition to those described herein, including buffers to store data throughout the coding pipelines illustrated and communication transceivers to manage communication with the communication network and the counterpart coder/decoder device. Such elements have been omitted from the foregoing discussion for clarity.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A method, comprising:
detecting a region of interest (ROI) from content of an image to be coded,
generating an obfuscated copy of content of the ROI;
partitioning the image into a plurality of spatial sub-units;
coding sub-unit(s) that are outside the ROI;
coding sub-unit(s) corresponding to the ROI;
processing the coded sub-unit(s) corresponding to the ROI by an access control technique;
coding the obfuscated copy of content of the ROI; and
compiling a file from the encrypted sub-unit(s) corresponding to the ROI, the coded sub-units that are outside the ROI, and the coded obfuscated copy of content of the ROI.

2. The method of claim 1, wherein the access control technique is encryption performed using an encryption key.

3. The method of claim 1, wherein the file conforms to a HEIF file syntax.

4. The method of claim 3, wherein the coded sub-unit(s) corresponding to the ROI and the coded obfuscated copy of content of the ROI are represented in an alternative group of the HEIF file syntax.

5. The method of claim 3, wherein the coded sub-unit(s) corresponding to the ROI and the coded obfuscated copy of content of the ROI are represented in a derived item of the HEIF file syntax.

6. The method of claim 4, wherein the file contains a second alternative group containing a plurality of items identifying access requirements for items of the alternative group in which the ROI and the obfuscated ROI are represented.

7. The method of claim 6, wherein the identified access requirements are decryption key identifiers.

8. The method of claim 6, wherein the identified access requirements are hierarchies of decryption key identifiers.

9. The method of claim 6, wherein the file contains a third alternative group containing a plurality of items identifying access requirements for items of the alternative group in which the ROI and the obfuscated ROI are represented.

10. The method of claim 1, wherein the coding of the sub-units that are outside the ROI and the obfuscated copy of content of the ROI are performed on a virtual image that compiles the sub-units that are outside the ROI and the obfuscated copy ROI into the virtual image.

11. The method of claim 1, wherein the coding of the sub-units that are outside the ROI and the sub-unit(s) corresponding to the ROI are performed on an image that contains content of the sub-units that are outside the ROI and the ROI.

12. The method of claim 1, wherein the generating generates replacement content of the ROI.

13. The method of claim 1, wherein the generating filters content of the ROI.

14. The method of claim 1, further comprising generating and coding a second obfuscated copy of content of the ROI.

15. The method of claim 1, wherein the image content is two-dimensional image content.

16. The method of claim 1, wherein the image content is volumetric image content.

17. A computer readable medium storing program instructions that, when executed by a processing device, case the processing device to:
detect a region of interest (ROI) from content of an image to be coded,
generate an obfuscated copy of content of the ROI;
partition the image into a plurality of spatial sub-units;
code sub-unit(s) that are outside the ROI;
code sub-unit(s) corresponding to the ROI;
process the coded sub-unit(s) corresponding to the ROI by an access control technique;
code the obfuscated copy of content of the ROI; and
compile a file from the encrypted sub-unit(s) corresponding to the ROI, the coded sub-units that are outside the ROI, and the coded obfuscated copy of content of the ROI.

18. The medium of claim 17, wherein the access control technique is encryption performed using an encryption key.

19. The medium of claim 17, wherein the file conforms to a HEIF file syntax.

20. The medium of claim 19, wherein the coded sub-unit(s) corresponding to the ROI and the coded obfuscated copy of content of the ROI are represented in an alternative group of the HEIF file syntax.

21. The medium of claim 20, wherein the file contains a second alternative group containing a plurality of items identifying access requirements for items of the alternative group in which the ROI and the obfuscated ROI are represented.

22. The medium of claim 21, wherein the identified access requirements are decryption key identifiers.

23. The medium of claim 21, wherein the identified access requirements are hierarchies of decryption key identifiers.

24. The medium of claim 21, wherein the file contains a third alternative group containing a plurality of items identifying access requirements for items of the alternative group in which the ROI and the obfuscated ROI are represented.

25. The medium of claim 17, wherein the coding of the sub-units that are outside the ROI and the obfuscated copy of content of the ROI are performed on a virtual image that compiles the sub-units that are outside the ROI and the obfuscated copy ROI into the virtual image.

26. The medium of claim 17, wherein the coding of the sub-units that are outside the ROI and the sub-unit(s) corresponding to the ROI are performed on an image that contains content of the sub-units that are outside the ROI and the ROI.

27. The medium of claim 17, wherein the generating generates replacement content of the ROI.

28. The medium of claim 17, wherein the generating generates filtered content of the ROI.

29. The medium of claim 17, wherein the programming instructions cause a second obfuscated copy of content of the ROI to be generated and coded.

30. The medium of claim 17, wherein the image content is two-dimensional image content.

31. The medium of claim 17, wherein the image content is volumetric image content.

32. A decoding method, comprising:
reviewing access rights of coded image data stored in a file representing a protected region of interest (ROI) of the coded image data,
when access rights of the ROI are met, decoding the protected ROI according to decryption and source decoding;
when access rights of the ROI are not met, decoding a coded representation of an obscured ROI according to source decoding;
decoding other elements of the coded image data; and
forming a recovered image from one of the (1) decoded protected ROI and (2) the decoded obscured ROI and the decoded other elements.

33. The method of claim 32, wherein the file conforms to a HEIF file syntax.

34. The method of claim 33, wherein the coded data of the ROI and coded data of the obscured ROI are represented in an alternative group of the HEIF file syntax.

35. The method of claim 34, wherein the file contains a second alternative group containing a plurality of items identifying access requirements for items of the alternative group in which the ROI and the obscured ROI are represented.

36. The method of claim 35, wherein the identified access requirements are decryption key identifiers.

37. The method of claim 35, wherein the identified access requirements are hierarchies of decryption key identifiers.

38. The method of claim 35, wherein the file contains a third alternative group containing a plurality of items identifying access requirements for items of the alternative group in which the ROI and the obfuscated ROI are represented.

39. A video processing unit, comprising:
a region of interest (ROI) detector having an input for a source image and an output for data representing a spatial location of an ROI detected from the source image,
an obfuscation unit having an input for the source image and an output for data representing obscured image data;
an access control unit having an input for image data representing the ROI and an output for access control processed ROI data;
an image packager to compile a file containing a virtual image compiled from the source image and the obscured ROI and the access control processed ROI.

40. A video processing unit, comprising:
a region of interest (ROI) detector having an input for a source image and an output for data representing a spatial location of an ROI detected from the source image,
an obfuscation unit having an input for the source image and an output for data representing obscured ROI image data;
an encoder having an input for the source image and an output for coded source image data, the source image data coded as a plurality of coding units;
an access control unit having an input for coded source image data and an output for access control processed coded data of ROI coding unit(s) and access control unprocessed coded unit data for non-ROI coding units;
an encoder having an input for the obscured ROI image data and an output for coded ROI data; and
an image packager to compile a file from the access control processed ROI coding unit(s), the access control unprocessed coded unit data for non-ROI coding units, and the coded obscured ROI image data.
